(19) United States
(12) Patent Application Publication
(10) Pub. No.: US 2026/0024345 A1
(43) Pub. Date: Jan. 22, 2026

(54) CAMERA, SYSTEM, AND METHOD FOR COUNTING VEHICLE MOVEMENT

(71) Applicant: HANWHA VISION CO., LTD., Seongnam-si (KR)

(72) Inventors: Na Yeon KIM, Seongnam-si (KR); Ho Jung LEE, Seongnam-si (KR); Yeon Woo KIM, Seongnam-si (KR)

(73) Assignee: HANWHA VISION CO., LTD., Seongnam-si (KR)

(21) Appl. No.: 19/225,435

(22) Filed: Jun. 2, 2025

(30) Foreign Application Priority Data
Jul. 18, 2024 (KR) 10-2024-0095163

(51) Int. Cl. G06V 20/54; G06V 10/94

(52) U.S. Cl. CPC G06V 20/54; G06V 10/945; G06V 2201/08

(57) ABSTRACT

An electronic device includes: at least one processor; and a memory storing instructions which, when executed by the at least one processor, causes the electronic device to: generate a plurality of lanes based on a user input on a screen on which an image captured by a camera is displayed; count vehicle movement based on the plurality of lanes; and generate an event for the counted vehicle movement based on a preset rule.

### CROSS-REFERENCE TO RELATED APPLICATION

This application is based on and claims priority under to Korean Patent Application No. 10-2024-0095163, filed on Jul. 18, 2024, in the Korean Intellectual Property Office, the disclosure of which is incorporated by reference herein in its entirety.

### BACKGROUND

### 1. Field

This disclosure relates to a camera, system, and method for counting vehicle movement.

### 2. Description of the Related Art

Currently, when it is necessary to identify the traffic volume of vehicles on a road or to crack down on speed violations, a method is utilized to extract vehicle movement through coils buried in the road and to recognize vehicle license plates through image information about vehicle movement to confirm vehicle information. However, this method has excessive maintenance costs, and thus, it is difficult to build and maintain all systems in this way. Accordingly, much research has been conducted to develop technologies to replace this method. Recently, a method of detecting vehicle movement through image analysis has been proposed.

### SUMMARY

Provided are a camera, system, and method for counting vehicle movement. However, the embodiments are examples and do not limit the scope of the disclosure.

Additional aspects will be set forth in part in the description which follows and, in part, will be apparent from the description, or may be learned by practice of the presented embodiments of the disclosure.

According to an aspect of the disclosure, an electronic device may include: at least one processor; and a memory storing instructions which, when executed by the at least one processor, causes the electronic device to: generate a plurality of lanes based on a user input on a screen on which an image captured by a camera is displayed; count vehicle movement based on the plurality of lanes; and generate an event for the counted vehicle movement based on a preset rule.

The instructions, when executed by the at least one processor, may further cause the electronic device to generate each of the plurality of lanes as a line that connects a start line to an end line and includes an arrow having a direction from the start line to the end line.

The instructions, when executed by the at least one processor, may further cause the electronic device to generate each of the plurality of lanes as a straight line or a curved line that connects the start line to the end line and is capable of being modified based on a user input.

The instructions, when executed by the at least one processor, may further cause the electronic device to generate each of the plurality of lanes as a combination of at least one straight line or at least one curved line that connects the start line to the end line based on a user input for at least one point on each of the plurality of lanes.

The preset rule may define a type of object and a type of act, where the instructions, when executed by the at least one processor, further causes the electronic device to generate the event for the counted vehicle movement based on the type of object performing the type of act within the plurality of lanes.

The preset rule may define a preset value of a traveling speed of an object, where the instructions, when executed by the at least one processor, further causes the electronic device to measure a speed of an object within the plurality of lanes, and generate the event based on the measured speed exceeding the preset value.

The preset rule may define a lane change prohibition condition, where the instructions, when executed by the at least one processor, further causes the electronic device to detect a movement of an object within the plurality of lanes, and generate the event based on the object performing a lane change that corresponds to the lane change prohibition condition.

According to an aspect of the disclosure, an electronic device may include: at least one processor; and a memory storing instructions which, when executed by the at least one processor, causes the electronic device to: generate a plurality of lanes or event areas based on a user input on a screen on which an image captured by a camera is displayed; and generate an event for an object passing through the plurality of lanes or the event areas based on a preset rule.

According to an aspect of the disclosure, a system for counting vehicle movement may include: a camera capturing an image of a road; a user interface configured to display the image captured by the camera; at least one processor; and a memory storing instructions which, when executed by the at least one processor, causes the system to: display a plurality of lanes based on a user input on the user interface on which the image captured by the camera is displayed, count vehicle movement based on the plurality of lanes, and generate an event for the counted vehicle movement based on a preset rule.

The instructions, when executed by the at least one processor, may further cause the system to generate and display each of the plurality of lanes as a line that connects a start line to an end line and includes an arrow having a direction from the start line to the end line.

The instructions, when executed by the at least one processor, may further cause the system to generate and display each of the plurality of lanes as a modifiable straight line or a modifiable curved line that connects the start line to the end line based on a user input.

According to an aspect of the disclosure, a method of counting vehicle movement by using a may include: generating a plurality of lanes on a screen on which an image captured by the camera is displayed; counting vehicle movement based on the plurality of lanes; and generating an event for the counted vehicle movement based on a preset rule.

The generating the plurality of lanes may include generating each of the plurality of lanes as a line that connects a start line to an end line and includes an arrow having a direction from the start line to the end line.

The generating the plurality of lanes may further include converting each of the plurality of lanes into a straight line or a curved line that is capable of being modified based on a user input.

The generating the plurality of lanes may further include converting each of the plurality of lanes into a combination of at least one straight line or at least one curved line based on a user input for at least one point on each lane.

According to an aspect of the disclosure, a non-transitory computer-readable storage medium may store a computer program which, when executed by at least one processor, executes the method including: generating a plurality of lanes on a screen on which an image captured by the camera is displayed; counting vehicle movement based on the plurality of lanes; and generating an event for the counted vehicle movement based on a preset rule.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram for explaining a configuration and operation of a system for counting vehicle movement, according to an embodiment;

FIG. 2 is a diagram for explaining a configuration and operation of a server included in a system for counting vehicle movement, according to an embodiment;

FIG. 3 is a diagram for explaining a configuration and operation of a processor included in a camera according to an embodiment;

FIG. 4 is a flowchart illustrating a method of counting vehicle movement, according to an embodiment; and

FIG. 5, FIG. 6, FIG. 7, FIG. 8, and FIG. 9 are diagrams for explaining a method of counting vehicle movement, according to one or more embodiments.

### DETAILED DESCRIPTION

Reference will now be made in detail to embodiments, examples of which are illustrated in the accompanying drawings, wherein like reference numerals refer to like elements throughout.

In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. As the disclosure allows for various changes and numerous embodiments, certain embodiments will be illustrated in the drawings and described in the detailed description.

Effects and features of the disclosure, and methods for achieving them will be clarified with reference to embodiments described below in detail with reference to the drawings. However, the disclosure is not limited to the following embodiments and may be embodied in various forms. Hereinafter, embodiments will be described in detail with reference to the accompanying drawings, wherein the same or corresponding elements are denoted by the same reference numerals throughout and a repeated description thereof is omitted.

Although the terms “first,” “second,” etc. may be used to describe various elements, these elements should not be limited by these terms. These terms are only used to distinguish one element from another.

The singular forms “a,” “an,” and “the” are intended to include the plural forms as well, unless the context clearly indicates otherwise. It will be further understood that the terms “includes” or “has” used herein specify the presence of stated features or components, but do not preclude the presence or addition of one or more other features or components. Sizes of components in the drawings may be exaggerated or reduced for convenience of explanation.

For example, because sizes and thicknesses of components in the drawings are arbitrarily illustrated for convenience of explanation, the disclosure is not limited thereto. It will be further understood that, when a region, component, unit, block, or module is referred to as being “on” another region, component, unit, block, or module, it may be directly on the other region, component, unit, block, or module or may be indirectly on the other region, component, unit, block, or module with intervening regions, components, units, blocks, or modules therebetween.

It will be further understood that, when a region, component, unit, block, or module is referred to as being connected to another region, component, unit, block, or module, it may be directly connected to the other region, component, unit, block, or module or may be indirectly connected to the other region, component, unit, block, or module with intervening regions, components, units, blocks, or modules therebetween. Various embodiments will now be described more fully with reference to the accompanying drawings for one of ordinary skill in the art to be able to perform the disclosure without any difficulty.

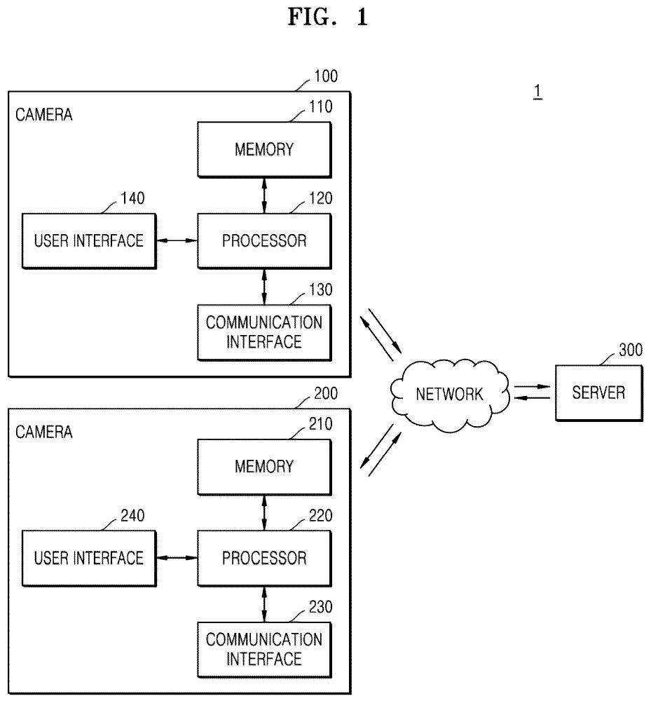

FIG. 1 is a diagram for explaining a configuration and operation of a system for counting vehicle movement (hereinafter, referred to as a vehicle movement counting system), according to an embodiment.

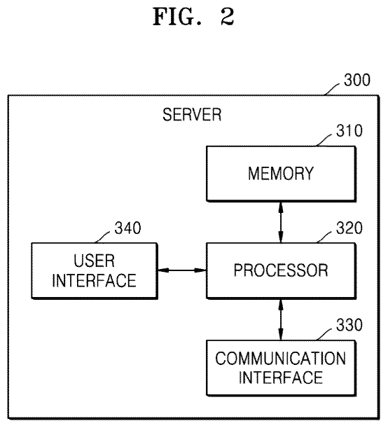

In addition, FIG. 2 is a diagram for explaining a configuration and operation of a server included in the vehicle movement counting system according to an embodiment. Referring to FIG. 1, a vehicle movement counting system 1 according to an embodiment may include cameras 100 and 200 and a server 300.

However, the disclosure is not limited thereto, and the vehicle movement counting system 1 may further include other elements or some elements may be omitted. Some elements of the vehicle movement counting system 1 may be separated into a plurality of devices, or a plurality of elements may be combined into one device. For example, although two cameras 100 and 200 are illustrated in FIG. 1, the vehicle movement counting system 1 may include one, two, or more cameras. The server 300 may be configured to control an operation of the vehicle movement counting system 1.

For example, the server 300 may be connected to the cameras 100 and 200 through a network to transmit and receive data to and from the cameras 100 and 200. The camera 100 according to an embodiment may include a memory 110, a processor 120, a communication interface 130, and a user interface 140. To generate an image, each of the cameras 100 and 200 may include an image sensor such as a complementary metal-oxide-semiconductor (CMOS) device or a charge-coupled device (CCD).

Hereinafter, the memory 110, the processor 120, the communication interface 130, and the user interface 140, which are elements of the camera 100, will be described, but the description may apply to elements of the camera 200.

The communication interface 130 may provide a function for communicating with an external device through the network. The communication interface 130 may be implemented by any one or any combination of a digital modem, a radio frequency (RF) modem, an antenna circuit, a WiFi chip, and related software and/or firmware.

For example, a request generated by the processor 120 of the camera 100 according to program code stored in a recording device such as the memory 110 may be transmitted to the external device through the network under the control of the communication interface 130. Conversely, a control signal, a command, content, or a file provided from the external device may be received by the camera 100 through the network and through the communication interface 130. For example, a control signal or a command of the external device received through the communication interface 130 may be transmitted to the processor 120 or the memory 110. A communication method is not limited, and may include not only a communication method using a communication network (e.g., a mobile communication network, wired Internet, wireless Internet, or a broadcasting network) that may be included in the network, but also short-range wireless communication between devices.

For example, the network may include at least one of a personal area network (PAN), a local area network (LAN), a campus area network (CAN), a metropolitan area network (MAN), a wide area network (WAN), a broadband network (BBN), and the Internet. Also, the network may include at least one of network topologies including, but not limited to, a bus network, a star network, a ring network, a mesh network, a star-bus network, and a tree or hierarchical network. Also, the communication interface 130 may communicate with an external server through the network.

A communication method is not limited, but the network may be a short-range wireless communication network. For example, the network may be a Bluetooth, Bluetooth low energy (BLE), or Wi-Fi communication network. Also, the camera 100 according to various embodiments of the disclosure may include the user interface 140.

The user interface 140 may include an interface for an input/output device. For example, the input device may include a device such as a keyboard or a mouse, and the output device may include a device such as a display for displaying a communication session of an application. In another example, the user interface 140 may include an interface for a device in which input and output functions are integrated into one such as a touchscreen. In a more detailed example, when the processor 120 of the camera 100 processes a command of a computer program loaded into the memory 110, a service screen or content configured by using data provided by the external device may be displayed on the display through the user interface. The memory 110 is a computer-readable recording medium, and may include a random-access memory (RAM), a read-only memory (ROM), or a permanent mass storage device such as a disk drive.

Also, program code for controlling the camera may be temporarily or permanently stored in the memory 110. For example, the vehicle movement counting system according to an embodiment may include a plurality of cameras, and vehicle movement may be counted by the server 300 communicating with the plurality of cameras.

For example, referring to FIG. 2, a plurality of lanes may be displayed on a screen of a user interface 340 on which an image captured by a camera is displayed by a processor 320 of the server 300. For example, the vehicle movement counting system 1 according to an embodiment may count vehicle movement by using each camera 100.

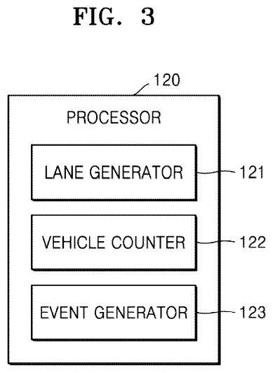

For example, referring to FIG. 1, a plurality of lanes may be displayed on a screen of the user interface 140 on which an image captured by a camera is displayed by the processor 120 of the camera 100. FIG. 3 is a diagram for explaining a configuration and operation of a processor included in a camera according to an embodiment.

Referring to FIG. 3, a processor 120 according to an embodiment may include a lane generator 121, a vehicle counter 122, and an event generator 123.

The lane generator 121 may generate a plurality of lanes based on a user's input on a screen on which an image captured by a camera is displayed.

The lane generator 121 according to an embodiment may generate each lane such that each lane connects a start line to an end line and is expressed in the form of an arrow having a direction from the start line to the end line.

The lane generator 121 according to an embodiment may generate each lane such that each lane is expressed in the form of a straight line or a curved line, which may be modifiable, based on a user's input for each lane expressed in the form of the arrow.

The lane generator 121 according to an embodiment may generate each lane expressed in the form of a combination of at least one straight line or curved line based on a user's input for at least one point on each lane expressed in the form of the arrow.

The vehicle counter 122 may count vehicle movement based on the plurality of lanes.

The event generator 123 may generate an event for the counted vehicle movement based on a preset rule.

According to some embodiments, at least one of the above three elements 121-123 of the processor 120 may be selectively included in or excluded from the processor 120.

Also, according to some embodiments, the above elements 121-123 of the processor 120 may be separated or combined to perform the above-described functions. The processor 120 and the above elements 121-123 of the processor 120 may be configured to execute instructions stored in the memory 110 or execute instructions according to at least one program code and code of an operating system stored in the memory 110.

The above elements 121-123 of the processor 120 may represent different functions of the processor 120 performed by the processor 120 according to a command provided by the program code stored in the memory 110.

The above elements 121-123 may be implemented as respectively dedicated circuits or a combination of one or more microprocessors and software modules in the processor 120. Alternatively, the above elements 121-123 may be software modules stored in the memory 110, 210 or 310 that are executed by the processor 120.

At least one of the components, elements, modules or units represented by a block as illustrated in FIGS. 1-3 may be embodied as various combinations of hardware, software and/or firmware structures that execute respective functions described above, according to an exemplary embodiment. For example, at least one of these components, elements, modules or units may use a direct circuit structure, such as a memory, processing, logic, a look-up table, etc. that may execute the respective functions through controls of one or more microprocessors or other control apparatuses. Also, at least one of these components, elements, modules or units may be specifically embodied by a module, a program, or a part of code, which contains one or more executable instructions for performing specified logic functions, and executed by one or more microprocessors or other control apparatuses. Also, at least one of these components, elements, modules or units may further include a processor such as a central processing unit (CPU) that performs the respective functions, a microprocessor, or the like. Two or more of these components, elements, modules or units may be combined into one single component, element, module or unit which performs all operations or functions of the combined two or more components, elements, modules or units. Also, at least part of functions of at least one of these components, elements, modules or units may be performed by another of these components, elements, modules or units. Further, although a bus is not illustrated in the above block diagrams, communication between the components, elements, modules or units may be performed through the bus. Functional aspects of these exemplary embodiments may be implemented in algorithms that execute on one or more processors. Furthermore, the components, elements, modules or units represented by a block or processing steps may employ any number of related art techniques for electronics configuration, signal processing and/or control, data processing and the like.

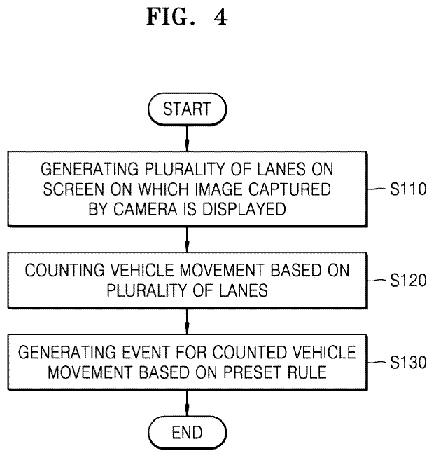

FIG. 4 is a flowchart illustrating a method of counting vehicle movement (hereinafter, referred to as a vehicle movement counting method), according to an embodiment.

In addition, the vehicle movement counting method according to an embodiment of FIG. 4 may be performed by the processor 120 included in the camera 100 or the processor 320 included in the server 300. Referring to FIG. 4, in the method of counting vehicle movement by using a camera according to an embodiment, generating a plurality of lanes on a screen on which an image captured by the camera is displayed may be performed in Operation S110.

The generating of the plurality of lanes, according to an embodiment, may include generating each lane connecting a start line to an end line and expressed in the form of an arrow having a direction from the start line to the end line.

The generating of the plurality of lanes, according to an embodiment, may include converting each lane expressed in the form of the arrow into the form of a straight line or curve that is modifiable.

The generating of the plurality of lanes, according to an embodiment, may include converting each lane expressed in the form of the arrow into a combination of at least one straight line or curve based on a user's input for at least one point on the lane.

In Operation S120, counting vehicle movement based on the plurality of lanes may be performed.

In Operation S130, generating an event for the counted vehicle movement based on a preset rule may be performed.

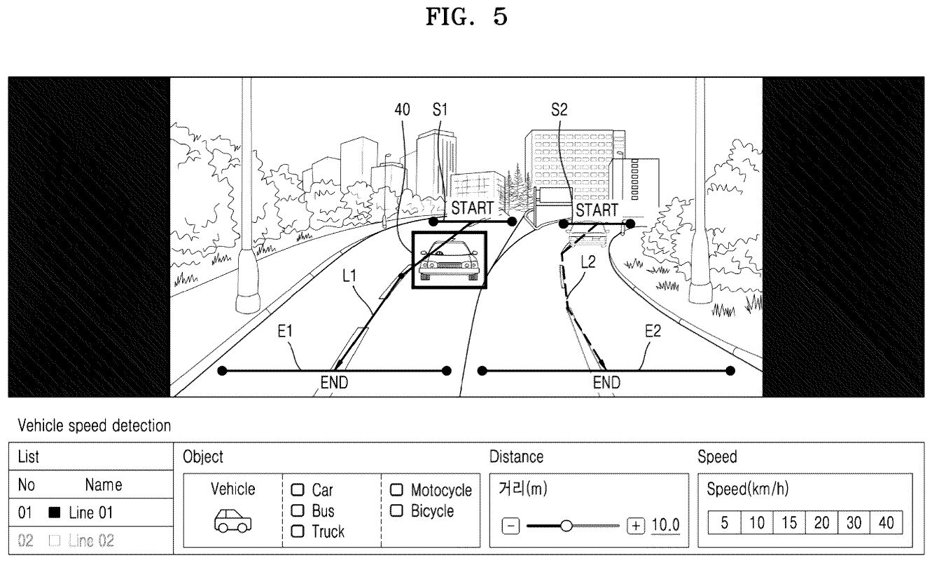

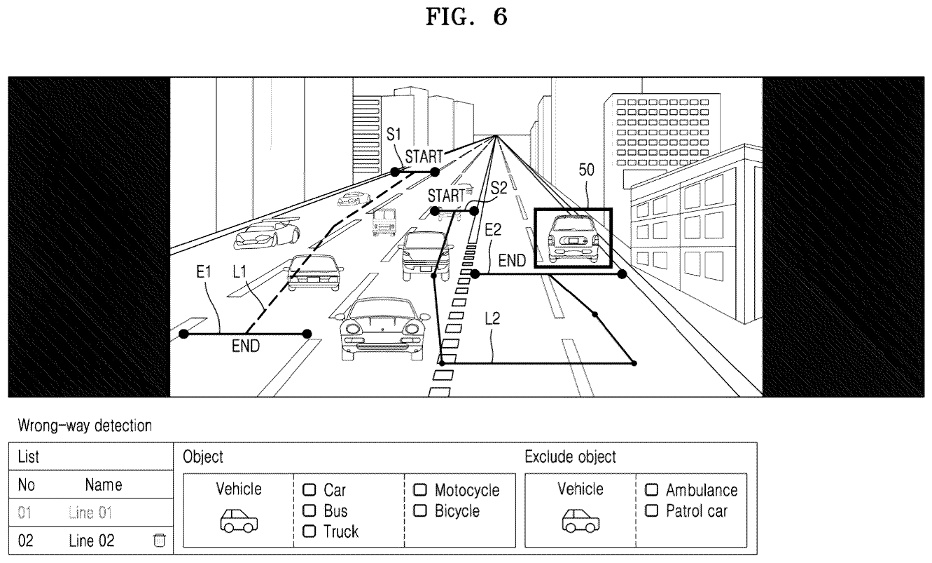

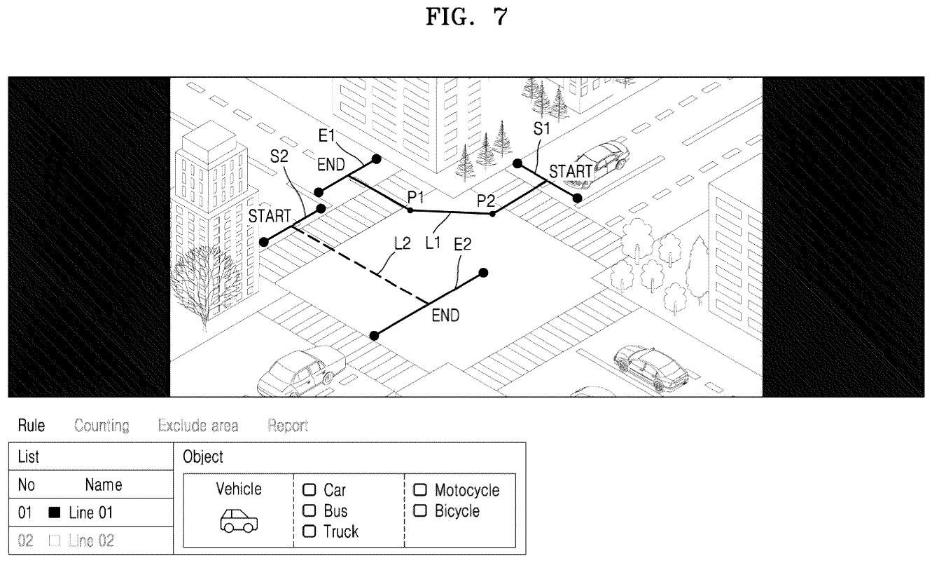

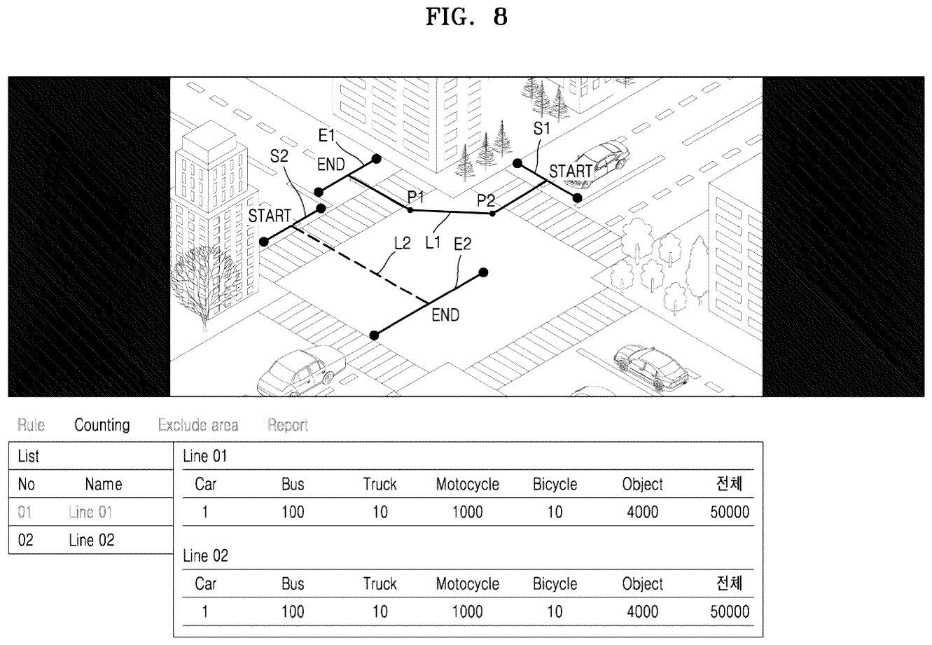

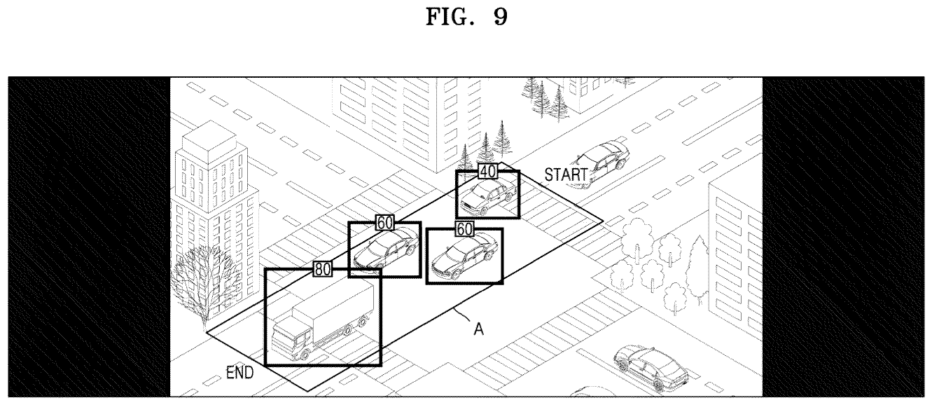

FIGS. 5 to 9 are diagrams for explaining a vehicle movement counting method according to various embodiments.

The vehicle movement counting method according to an embodiment may be used in a place where the traffic volume of vehicles needs to be identified through a camera, or in a business field where a fine has to be imposed on a vehicle that has committed an illegal act.

For example, the number of vehicles making a left turn, a right turn, or going straight may be identified, or an event may be generated for a vehicle that has committed an illegal U-turn or a wrong way detection. Referring to FIGS. 5 to 9, an embodiment of a screen on which an image captured by a camera photographing a road is displayed according to an embodiment is illustrated.

In addition, the vehicle movement counting method according to an embodiment of FIGS. 5 to 9 may be performed by the processor 120 included in the camera 100 or the processor 320 included in the server 300. For example, as illustrated in FIG. 5, a plurality of lanes may be displayed on a screen on which an image captured by a camera photographing a road is displayed.

For example, a plurality of lanes desired by a user may be generated and displayed based on a user's input (e.g., mouse click, drag and drop, point addition, or point deletion) within the screen. For example, each lane may connect a start line to an end line and be expressed in the form of an arrow having a direction from the start line to the end line. For example, each lane may also be expressed in the form of a line other than an arrow. For example, as illustrated in FIG. 5, an event for cracking down on a speeding vehicle, according to an embodiment, may be generated.

For example, in an event for cracking down on a speeding vehicle, the speed of a vehicle that has entered between a start line and an end line may be detected. For example, a user may draw, on the screen, a section he or she wants to detect As illustrated in FIG. 5, a first lane L1 connecting a first start line S1 to a first end line E1 and a second lane L2 connecting a second start line S2 to a second end line E2 may be generated. In addition, the user may select an object he or she wants to detect. In addition, the user may measure the distance of the section he or she wants to detect, and input a distance value. In addition, the user may select a speed he or she wants to detect. In this case, as illustrated in FIG. 5, the vehicle speed may be detected for a vehicle 40 located between the first start line S1 and the first end line E1. In addition, a crackdown event may be generated when the speed of the vehicle 40 is measured to be greater than or equal to a preset value. For example, as illustrated in FIG. 6, a wrong way detection (e.g., U-turn prohibition crackdown) event according to an embodiment may be generated.

For example, in an event for cracking down on a U-turn vehicle, a crackdown event may be generated for a vehicle that has entered both the start line and the end line. For example, the user may draw, on the screen, a section he or she wants to detect. In addition, the user may select an object he or she wants to detect. In addition, the user may select an object (e.g., an ambulance or a police car) that he or she wants to exclude from a detection target. In this case, as illustrated in FIG. 6, a U-turn prohibition event may be generated for a vehicle 50 that has passed both the second start line S2 and the second end line E2. In addition, a lane change prohibition crackdown event may be generated for a vehicle that has passed both the first start line S1 and the first end line E1. For example, a template including a start line and an end line for sections (e.g., left turn, right turn, and U-turn) that the user wants to detect may be stored in advance.

In this case, the user may draw a section that he or she wants to detect, on the screen through fine adjustment by using the template stored in advance. For example, as illustrated in FIGS. 7 and 8, vehicle counting according to an embodiment may be performed.

For example, the traffic volume may be counted for a left turn, right turn, or straight vehicle. For example, the user may draw, on the screen, a section that he or she wants to detect. In addition, the user may select an object that he or she wants to detect in a rule tap. In this case, as illustrated in FIG. 8, the number of counted vehicles may be checked in a counting tap. For example, the server 300 included in the vehicle movement counting system 1 according to an embodiment may represent a cloud server.

In the vehicle movement counting method according to an embodiment, when real-time counting of the camera 100 is difficult, the camera 100 may store a corresponding image and transmit the stored image to the server 300. For example, the camera 100 may capture an image that is difficult to count in real time and store the captured image or transmit the captured image to the server 300. In this case, the server 300 may count the vehicle movement of the stored image or captured image received from the camera 100. In an embodiment, the camera 100 may reload the stored image or captured image and count the vehicle movement. For example, in the vehicle movement counting method according to an embodiment, an undefined object that is not defined by the user may be detected in addition to an object defined by the user.

In this case, the undefined object may be displayed as an undefined item in the detection target (object) item. In the vehicle movement counting method according to an embodiment, after the user completes inputting a plurality of lane drawings, a plurality of lanes may be displayed as an arrow UI (from a start line to an end line.

In the vehicle movement counting method according to an embodiment, each lane may be converted into a modifiable straight line or curve and displayed, based on a user's input for each lane expressed in the form of an arrow.

For example, when the user selects a lane to modify the arrow UI displayed on the screen, each lane may be converted into a modifiable straight line UI or curve UI and displayed. In addition, each lane expressed as an arrow UI may be converted into a combination of at least one straight line or curve and displayed, based on a user's input for at least one point on the lane. For example, as illustrated in FIG. 7, when the user selects a lane to modify the first lane L1 displayed on the screen, the first lane L1 may be converted into a modifiable curve UI and displayed.

In addition, when the user selects a lane to modify the first lane L1 displayed on the screen, the first lane L1 may be converted into a combination of a straight line UI and a curve UI, which are modifiable, and displayed. In addition, the first lane L1 may be converted into a curved UI and displayed, based on a user's input for a first point P1 and a second point P2 on the lane. In an embodiment, the first lane L1 may be converted into a combination of three straight lines UI and displayed, based on a user's input for the first point P1 and the second point P2 on the lane. For example, a camera according to an embodiment may include a processor that generates a plurality of lanes or event areas on a screen on which an image captured by the camera is displayed.

In addition, a lane generator included in the processor according to an embodiment may generate the plurality of lanes or the event areas based on a user's input on the screen on which an image captured by the camera is displayed. In addition, an event generator included in the processor according to an embodiment may generate an event for an object passing through the plurality of lanes or the event areas based on a preset rule.

For example, as illustrated in FIG. 9, the lane generator may generate an event area A including a start line and an end line.

For example, the lane generator may generate the event area A having each of the start line and the end line as one side. For example, the event area A is not limited to a square and may be generated as an area of various shapes. For example, as illustrated in FIG. 9, the event generator may generate an event for an object passing through the event area A.

For example, the event generator may measure the speed of a vehicle passing through the event area A and display the speed of each vehicle. For example, an event for an object passing through the event area A may include speed measurement, object detection, movement path detection (e.g., left turn, right turn, or U-turn). A device and/or system described herein may be implemented using hardware components, software components, or a combination thereof.

A device and an element described in embodiments may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions. A processing device may run an operating system (OS) and one or more software applications that run on the OS. Also, the processing device may access, store, manipulate, process, and create data in response to execution of software. For easy understanding, one processing device is used, but it will be understood by one of ordinary skill in the art that a processing device may include multiple processing elements and/or multiple types of processing elements. For example, the processing device may include multiple processors or a processor and a controller. In addition, other processing configurations, such as parallel processors, may be implemented. Software may include a computer program, a piece of code, an instruction, or a combination thereof, to independently or collectively instruct or configure a processing device to operate as desired.

Software and/or data may be embodied permanently or temporarily in any type of machine, component, physical or virtual equipment, computer storage medium or device, or a transmitted signal wave, to provide instructions or data to or to be interpreted by a processing device. Software may also be distributed over network coupled computer systems so that the software is stored and executed in a distributed fashion. Software and data may be stored in one or more computer-readable recording media. A method according to an embodiment may be embodied as program commands executable by various computer means and may be recorded on a computer-readable medium.

The computer-readable medium may include program commands, data files, and data structures separately or in combinations. The program commands recorded on the computer-readable medium may be specially designed and configured for embodiments or may be well-known to and be usable by one of ordinary skill in the art of computer software. Examples of the computer-readable recording medium include a magnetic medium such as a hard disk, a floppy disk, or a magnetic tape, an optical medium such as a compact disc read-only memory (CD-ROM) or a digital versatile disc (DVD), a magneto-optical medium such as a floptical disk, and a hardware device specially configured to store and execute program commands such as a ROM, a random-access memory (RAM), or a flash memory. Examples of the program commands include advanced language code that may be executed by a computer by using an interpreter or the like as well as machine language code made by a compiler. The described hardware device may be configured to operate as one or more software modules in order to perform an operation of an embodiment, and the reverse is the same. According to an embodiment as described above, a camera capable of effectively counting vehicle movement by displaying a plurality of lanes within a screen on which an image is displayed, and a system and method for effectively counting vehicle movement may be implemented.

However, the scope of the disclosure is not limited by this effect. Although the embodiments have been described by the limited embodiments and the drawings as described above, various modifications and variations are possible by one of ordinary skill in the art from the above description.

For example, appropriate results may be achieved even when the described techniques are performed in a different order from the described method, and/or the described elements such as a system, a structure, an apparatus, and a circuit are combined or integrated in a different manner from the described method or replaced or substituted by other elements or equivalents. Hence, other implementations, other embodiments, and equivalents of the claims are within the scope of the following claims.

It should be understood that embodiments described herein should be considered in a descriptive sense only and not for purposes of limitation.

Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An electronic device comprising:
at least one processor; and
a memory storing instructions which, when executed by the at least one processor, causes the electronic device to:
generate a plurality of lanes based on a user input on a screen on which an image captured by a camera is displayed;
count vehicle movement based on the plurality of lanes; and
generate an event for the counted vehicle movement based on a preset rule.

2. The electronic device of claim 1, wherein the instructions, when executed by the at least one processor, further causes the electronic device to generate each of the plurality of lanes as a line that connects a start line to an end line and includes an arrow having a direction from the start line to the end line.

3. The electronic device of claim 2, wherein the instructions, when executed by the at least one processor, further causes the electronic device to generate each of the plurality of lanes as a straight line or a curved line that connects the start line to the end line and is capable of being modified based on a user input.

4. The electronic device of claim 2, wherein the instructions, when executed by the at least one processor, further causes the electronic device to generate each of the plurality of lanes as a combination of at least one straight line or at least one curved line that connects the start line to the end line based on a user input for at least one point on each of the plurality of lanes.

5. An electronic device comprising:
at least one processor; and
a memory storing instructions which, when executed by the at least one processor, causes the electronic device to:
generate a plurality of lanes or event areas based on a user input on a screen on which an image captured by a camera is displayed; and
generate an event for an object passing through the plurality of lanes or the event areas based on a preset rule.

6. A system for counting vehicle movement, the system comprising:
a camera capturing an image of a road;
a user interface configured to display the image captured by the camera;
at least one processor; and
a memory storing instructions which, when executed by the at least one processor, causes the system to:
display a plurality of lanes based on a user input on the user interface on which the image captured by the camera is displayed,
count vehicle movement based on the plurality of lanes, and
generate an event for the counted vehicle movement based on a preset rule.

7. The system of claim 6, wherein the instructions, when executed by the at least one processor, further causes the system to generate and display each of the plurality of lanes as a line that connects a start line to an end line and includes an arrow having a direction from the start line to the end line.

8. The system of claim 7, wherein the instructions, when executed by the at least one processor, further causes the system to generate and display each of the plurality of lanes as a modifiable straight line or a modifiable curved line that connects the start line to the end line based on a user input.

9. A method of counting vehicle movement by using a camera, the method comprising:
generating a plurality of lanes on a screen on which an image captured by the camera is displayed;
counting vehicle movement based on the plurality of lanes; and
generating an event for the counted vehicle movement based on a preset rule.

10. The method of claim 9, wherein the generating the plurality of lanes comprises generating each of the plurality of lanes as a line that connects a start line to an end line and includes an arrow having a direction from the start line to the end line.

11. The method of claim 10, wherein the generating the plurality of lanes further comprises converting each of the plurality of lanes into a straight line or a curved line that is capable of being modified based on a user input.

12. The method of claim 10, wherein the generating the plurality of lanes further comprises converting each of the plurality of lanes into a combination of at least one straight line or at least one curved line based on a user input for at least one point on each lane.

13. A non-transitory computer-readable storage medium storing a computer program which, when executed by at least one processor, executes the method of claim 9.

14. The electronic device of claim 1, wherein the preset rule defines a type of object and a type of act, and
wherein the instructions, when executed by the at least one processor, further causes the electronic device to generate the event for the counted vehicle movement based on the type of object performing the type of act within the plurality of lanes.

15. The electronic device of claim 14, wherein the preset rule defines a preset value of a traveling speed of an object, and
wherein the instructions, when executed by the at least one processor, further causes the electronic device to measure a speed of an object within the plurality of lanes, and generate the event based on the measured speed exceeding the preset value.

16. The electronic device of claim 14, wherein the preset rule defines a lane change prohibition condition, and
wherein the instructions, when executed by the at least one processor, further causes the electronic device to detect a movement of an object within the plurality of lanes, and generate the event based on the object performing a lane change that corresponds to the lane change prohibition condition.
